(19) United States
(12) Patent Application Publication
(10) Pub. No.: US 2024/0054008 A1
(43) Pub. Date: Feb. 15, 2024

(54) APPARATUS AND METHOD FOR PERFORMING A TASK

(71) Applicant: Kabushiki Kaisha Toshiba, Tokyo (JP)

(72) Inventors: Harit PANDYA, Cambridge (GB); Rudra POUDEL, Cambridge (GB); Stephan LIWICKI, Cambridge (GB)

(73) Assignee: Kabushiki Kaisha Toshiba, Tokyo (JP)

(21) Appl. No.: 17/819,468

(22) Filed: Aug. 12, 2022

(51) Int. Cl. G06F 9/48; G06N 3/04

(52) U.S. Cl. CPC G06F 9/4843; G06N 3/0454

(57) ABSTRACT

An apparatus for performing a task, the task being a sequence of actions performed to achieve a goal, the apparatus comprising:
at least one sensor for obtaining observations of the apparatus;
a controller configured to receive a control signal to move said apparatus; and
a processor,
said processor being configured to:
   receive information concerning the goal;
   determine the sequence of actions to reach said goal, the sequence of actions being subject to at least one constraint; and
   provide a control signal to said controller for the next action in said sequence of actions,
   wherein said processor is configured to determine the sequence of actions by processing observations received by said sensors to obtain information concerning the at least one constraint and performing stochastic optimisation to determine the sequence of actions where the at least one constraint is represented as a cost in said stochastic optimisation, the stochastic optimisation receiving an initial estimate of the next action.

### FIELD

Embodiments described herein are concerned with task performing apparatus and methods, and methods and systems of the training thereof.

### BACKGROUND

Many machine learning problems can be modelled as a task. In such a task, an agent attempts to satisfy a goal in view of various constraints. An example of such a task is navigation where a vehicle will attempt to reach a location (goal) in view of constraints provided by obstacles and also the allowed movement actions of the vehicle.

### BRIEF DESCRIPTION OF THE DRAWINGS

FIG. 1A is an illustration of an autonomous wheeled vehicle in accordance with example embodiments;

FIG. 1B is an illustration of an autonomous aerial vehicle in accordance with example embodiments;

FIG. 1C is an illustration of an example environment that can be navigated by an autonomous vehicle in accordance with example embodiments;

FIG. 1D is a schematic of the control system of the vehicle of FIGS. 1A and 1B;

FIG. 2 is a flow chart showing a method for performing a task in accordance with an embodiment;

FIG. 3 is a flow chart showing a method for performing a task in accordance with an embodiment;

FIG. 4 is a representation of the input from LiDAR sensors;

FIG. 5 is a schematic of a system for performing a task in accordance with an embodiment;

FIG. 6 is a schematic showing the vehicle/robot dynamic model in more detail;

FIG. 7 is a diagram showing how costs are modelled as constraints within a stochastic optimisation model;

FIG. 8 shows examples of robot navigating in a complex dynamic scene using a method in accordance with an embodiment, the upper 5 figures are online reconstructions of the current environment and the corresponding lower 5 figures are the ground truth maps;

FIG. 9 shows four environments that are navigated by a robot using a method in accordance with an embodiment, the solid line shows the motion of the robot and the dotted lines show the motion of the dynamic obstacles.

### DETAILED DESCRIPTION

In a first embodiment, an apparatus for performing a task is provided, the task being a sequence of actions performed to achieve a goal, the apparatus comprising:
at least one sensor for obtaining observations of the apparatus;
a controller configured to receive a control signal to move said apparatus; and
a processor,
said processor being configured to:
   receive information concerning the goal;
   determine the sequence of actions to reach said goal, the sequence of actions being subject to at least one constraint; and
   provide a control signal to said controller for the next action in said sequence of actions,
   wherein said processor is configured to determine the sequence of actions by processing observations received by said sensors to obtain information concerning the at least one constraint and performing stochastic optimisation to determine the sequence of actions where the at least one constraint is represented as a cost in said stochastic optimisation, the stochastic optimisation receiving an initial estimate of the next action.

The disclosed system provides an improvement to computer functionality by allowing computer performance of a function not previously performed by a computer. Specifically, the disclosed system provides for the fast updating of an agent (vehicle etc) to perform a task in a dynamic environment even when data concerning the environment is multidimensional. This is provided by the modelling of the tasks as a stochastic optimisation problem where the constraints are modelled as costs. This allows each of the costs to be modelled independently and then combined in a stochastic model. The convergence of the stochastic model is improved via the use of an estimate of the next action.

In an embodiment, the input estimate is obtained from a reinforcement learning policy. The reinforcement learning policy or module may be of any time, in an embodiment, a proximal policy optimisation algorithm (PPO) is used.

Using the above arrangement, it is possible for the processor to process observations concerning the constraints using a plurality of parallel processing branches, such that each branch is allocated to a different constraint. This allows the constraints to be modelled and trained independently of the main task.

The above can be used for many different types of tasks, for example, robot navigation with constraints, picking arm manipulation with constraints, viewpoint planning for reconstruction in real environments, etc. In an embodiment, the task comprises moving at least part of an apparatus to achieve a goal, the sequence of actions being a sequence of movements.

In one embodiment, the apparatus is a vehicle or robot, the task is a navigation task and the goal is a location. The location may be a location described by coordinates or the location of an object to be picked up etc. The location may be a location to which the whole vehicle/robot should be moved or just part of the vehicle/robot should be moved—for example, the part of the vehicle/robot may be the arm of the robot.

In such a task, at least one of the constraints may comprise navigating to avoid dynamic obstacles. In an embodiment, this may be achieved constraint relating to avoiding dynamic obstacles may be processed to produce an occupancy map of the dynamic obstacles. An occupancy map provides a probability distribution of the likelihood of a position being occupied at a time t. In an embodiment a plurality of occupancy maps are produced, for example, at different times up to time horizon H.

In an embodiment, the processor is configured to produce an occupancy map or occupancy maps of the dynamic obstacles using a neural network, wherein the input for the neural network is a time series of earlier observations of the dynamic obstacles.

The above framework which allows the constraints to be processed in different processing branches and therefore different constraints can be processed differently. For example, at least one of the constraints may comprise navigating to avoid static obstacles.

In an embodiment at least one of the constraints requires the apparatus to move the shortest distance to reach the goal.

When there are a plurality of constraints, the processor can be configured to apply a weighting to each costs derived from a constraint such that the costs are applied with variable weightings. This allows, for example, the costs for avoidance of static variables to be given a larger weighting than the costs for avoiding dynamic obstacles.

In an embodiment, the input to the reinforcement learning module is a hidden state of an recurrent neural network “RNN”, the RNN being used to produce a predictions of at least one future observation. The input to the RNN may be a latent representation of the observations. The RNN may also receive the current action of the apparatus as an input. This may be determined from odometry measurements.

In a further embodiment, a further input to the RNN is the goal. However, it is also possible for the goal not to be provided to the RNN at this stage and for the prediction to be made independent of the goal.

In an embodiment, the processor is configured to provide probability distributions relating to predictions of future observations from the RNN to the stochastic optimiser.

The input of an initial estimate into the stochastic optimise allows the stochastic optimiser to converge more quickly. The initial estimate may be of just the next action or the sequence of actions to the goal.

In an embodiment, the observations are LiDAR data.

The goal may be the final goal or it might be a waypoint which forms a “sub-goal” on the way to the final goal.

In a further embodiment, an apparatus for performing navigation to a goal is provided, the apparatus comprising:
at least one sensor for obtaining observations of the apparatus
a controller configured to receive a control signal to move said apparatus, and
a processor,
said processor being configured to:
   receive information concerning the goal,
   determine a path to said goal subject to at least one constraint, the path being a sequence of actions; and
   provide a control signal to said controller for the next action to move said apparatus to said goal,
   wherein said processor determines a path to said goal subject to at least one constraint by processing observations received by said sensors to determine information concerning the at least one constraint, determining an estimate of the next action and performing stochastic optimisation to determine the path wherein the at least one constraint is represented as a cost in said stochastic optimisation and the estimate of the next action is provided as an input.

In a yet further embodiment, an apparatus for performing a task is provided, said task comprising a goal and a plurality of constraints,
the apparatus comprising:
   an input for receiving image data relating to observations;
   a processor; and
   an output for outputting a control signal, the processor being configured to;
receive information indicating the goal of the apparatus;
   receive said image data and determine from said image data information concerning the constraints and the current progress of said apparatus towards said goal;
   and predict the next action for the apparatus to progress towards the goal,
wherein predicting the next action comprises performing optimisation using the constraints as costs during the optimisation, the optimisation receiving an input estimate of the next action.

The above provides a novel planning framework that can combine several constraints, both deep and analytical, and solves them in continuous space jointly using stochastic optimization on-the-fly without any retraining of the models. It also provides a safe indoor navigation approach that can steer the robot through complex environments in the presence of dynamic obstacles using LiDAR measurements and odometry.

The embodiments described herein use deep networks for encoding the range measurements and thus the ground poses of other obstacles are not required. Also, as the environment is reconstructed, there is no need map the object locations apriori. The above embodiments use deep recurrent networks to predict obstacles trajectories so that the approach described herein can predict more accurate trajectories (or sequence of actions) for a longer horizon. Also, the use of a deep reinforcement learning solution as an initial guess to warm-start the optimization process, aids the optimization process to maximize future rewards.

The above embodiments allow disentangling of the task into two (or more) sub-tasks of goal reaching (main task) and dynamic collision avoidance (constraints) so that the approach generalizes better since it is not “end-to-end”. Also, a modular online planning approach is presented that can jointly optimize sub-tasks on-the-fly without any modifications or retraining of the deep reinforcement policy.

In an embodiment, the navigation task is disentangled into two sub-tasks of: (I) goal reaching and (ii) dynamic collision avoidance. Recurrent neural networks (RNNs) are trained for learning the robot's and obstacle's dynamical models from the data. Considering each task as a constraint, an approach is presented for multi-constraint planning in deep learning based dynamical systems. The approach jointly solves the required constraints, analytical or learning based, by computing an optimal action that minimizes the mean expected cost for a planning horizon. To solve the distant horizon task, in an embodiment, a waypoint based planning strategy is used. Further, a partial occupancy map may be maintained, which is reconstructed online while navigating. From this, a collision free waypoint may be selected and provided as a goal.

The embodiments described herein tackles constraints models in a modular fashion so robot configurations (and other constraints) can be changed on-the-fly without retraining.

Further, the optimization can handle both deep networks and analytical kino-dynamic models. Also a solution is validated through all the constraints making sure that solution is feasible and safe.

There are several advantages in the multi-task planning formulation of the problem described above. Firstly, it is possible to add additional constraints such as robot's dynamics, smoothness etc. on-the-fly. Secondly, the framework can handle analytical as well as deep network based dynamic constraints, for example, evolution of robot's trajectory depends upon its dynamics which is an analytic constraint. Whereas trajectory of dynamic obstacles is better predicted by a deep neural network and is difficult to expressed in a closed form.

Agent systems and methods control entities, which could be real (e.g. physical) or simulated, based on observations of their context, e.g. based on observations of the environment of the entity and/or the state of the entity. Such agents may control the entity to perform a series of actions in order to perform a specified task. One task is navigating within cluttered, realistic indoor environments. In particular, agents struggle to control entities to navigate to goal objects while avoiding collisions in the presence of both static and dynamic (i.e. moving) obstacles. Being able to navigate while avoiding collisions is important in facilitating robots to perform tasks such as autonomous driving of road and aerial vehicles, delivering heavy boxes to addresses on busy streets, bussing a table at a restaurant and delivering syringes to hospital operating rooms, all scenarios where dynamic obstacles such as humans and vehicles are likely to be moving.

To assist in understanding of embodiments described herein, a specific example is initially presented. It should be understood that this specific example is provided for assistance in understanding these embodiments, and it should not be considered as limiting the scope of the claims or the description thereafter.

Autonomous Wheeled Vehicle

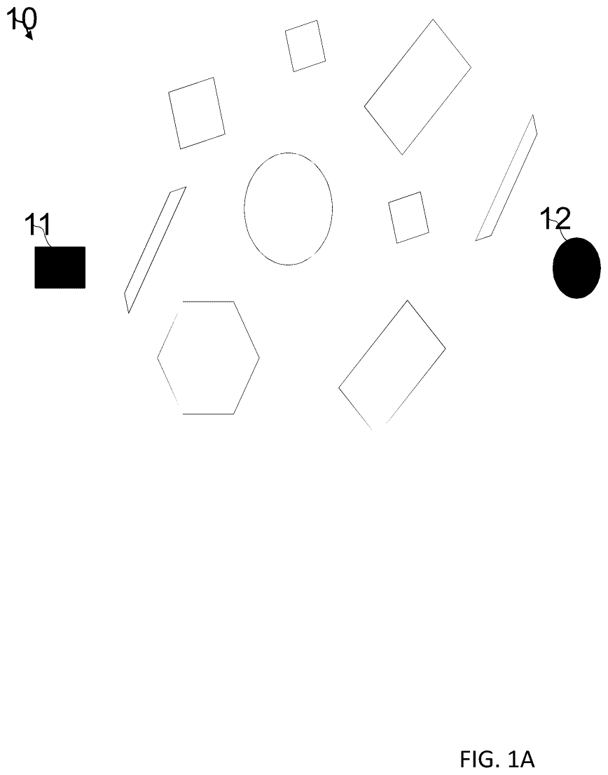

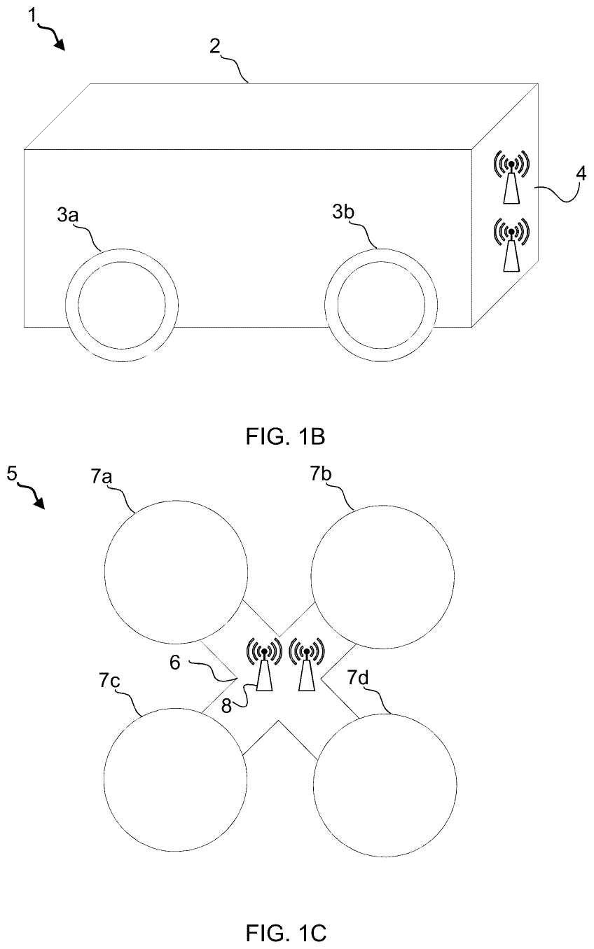

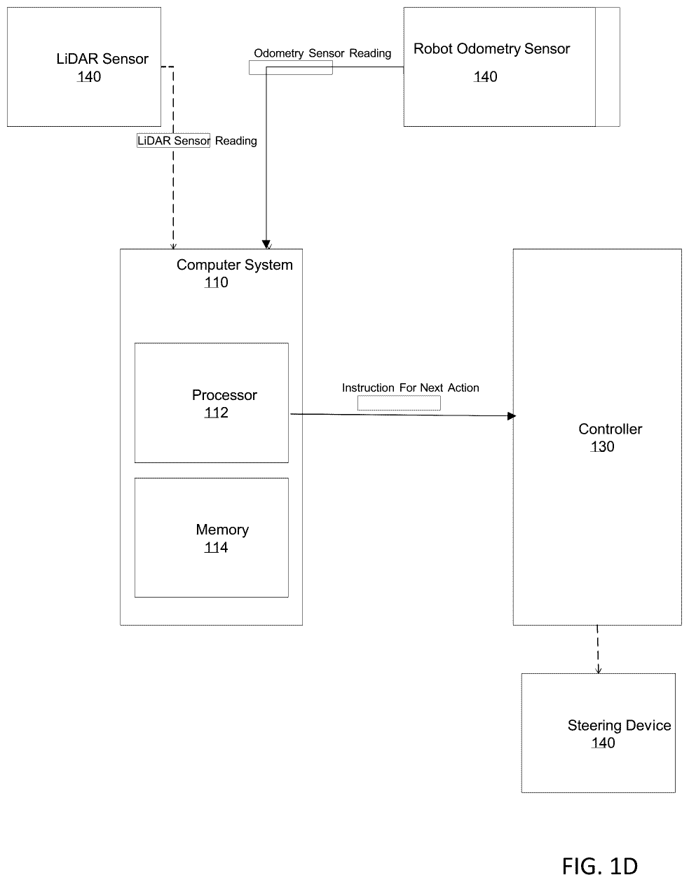

FIG. 1A is an illustration of an autonomous wheeled vehicle 1, e.g. an automated guided vehicle, in accordance with example embodiments.

The autonomous wheeled vehicle 1 includes a body 2, wheels 3, and a camera 4. The autonomous wheeled vehicle 1 may include additional elements to those shown, for example: a vacuum suction element such that the automated wheeled vehicle can be used as an automatic vacuum cleaner; and/or a fork and/or a cargo bed such that objects can be collected and/or delivered by the autonomous wheeled vehicle.

The body 2 includes one or more motors that can be used to rotate the wheels 3 and a steering system, e.g. a rack and pinion, whereby at least some of the wheels 3 can be turned to move in a desired direction. The body 2 also includes a control system, e.g. one or more computing devices that can be used to cause movements to be performed. For example, the control system may cause the wheels to be rotated by the motor to move the automated wheeled vehicle forwards (and, if supported, to rotate the wheels in the opposite direction, to move the autonomous vehicle backwards) and cause the steering system to rotate the wheels to turn the autonomous vehicle. The control system may determine the movements to be performed itself, e.g. using the method described with respect to FIG. 1D, or may receive an indication of the action to be performed from an external computer system using network hardware, e.g. a wireless transceiver. The body 2 also includes a power source (e.g. a battery and/or a solar panel) or a connection to a power source (e.g. a mains connection) such that energy can be provided to the one or more motors, the steering system, and the control system.

The wheels 3 may include four wheels: the wheels 3a, 3b and two wheels (not shown) opposite to these, e.g. positioned against the opposite side (not shown) of the body 2 to the wheels 3a, 3b. Each two wheels of the four wheels, e.g. the wheel 3a and the wheel opposite, and the wheel 3b and the wheel opposite, may be connected by an axle extending through the body 2. At least one of the axles may be connected to the motor such that the respective two wheels connected to it can be rotated by the motor. At least one of the axles may be connected to the steering system such that the respective two wheels can be turned using the steering system.

The camera 4 is capable of capturing images. In this embodiment, a single camera is provided capturing 2D images. The camera is coupled to the control system in the body 2. The camera is configured to capture one or more images, e.g. in response to a request received from the control system, and to send the one or more images to the control system. The control system may process the one or more images itself to determine the one or more movements to be performed based on the one or more images or may transmit the one or more images to an external computer system, using network hardware such as a wireless transceiver, so that the external computer system can determine the one or more movements to be performed based on the one or more images.

Autonomous Aerial Vehicle

FIG. 1B is an illustration of an autonomous aerial vehicle 5, e.g. an unmanned aerial vehicle or drone, in accordance with example embodiments.

The autonomous aerial vehicle 5 includes a body 6, propellers 7, and a camera 8. The autonomous wheeled vehicle 8 may include additional elements to those shown. For example, a payload holding or attachment element, such that the autonomous aerial vehicle can be used to collect and/or deliver objects.

The body 6 includes a respective motor for each of the propellers 7 which can be used to rotate the respective propeller. The body 6 also includes a control system, e.g. one or more computing devices that can be used to cause movements to be performed. For example, the control system may cause the motor to rotate the propellers and control the speed at which the motor rotates the propellers, such that the autonomous aerial vehicle can ascend and descend, move forwards and/or backwards, and turn. The control system may determine the movements to be performed itself, e.g. using the method described with respect to FIG. 1D, or may receive an indication of the action to be performed from an external computer system using network hardware, e.g. a wireless transceiver. The movements determined and/or received may be at a higher level of abstraction than the operations performable by the autonomous aerial vehicle, and the control system may translate these more abstract movements into operations performable by the aerial vehicle. For example, the more abstract movements may be move forwards, turn left and turn right, and the control system may translate these into differentials between the speeds at which the propellers 7 are rotated by the motor. The body 6 also includes a power source (e.g. a battery and/or a solar panel) or a connection to a power source (e.g. a mains connection) such that energy can be provided to the one or more motors and the control system.

The propellers 7 may include four propellers 7a, 7b, 7c and 7d. As described, each of the propellers 7a-7d may be rotated by a respective motor located on the body 6, and one or more of the propellers 7a-7d may be rotated at a different speed to another one or more of the propellers 7a-7d such that the aerial autonomous vehicle 5 turns left or right, or moves forward.

The camera 8 is capable of capturing images. In this embodiment, a single camera is provided capturing 2D images. The camera is coupled to the control system in the body 6. The camera is configured to capture one or more images, e.g. in response to a request received from the control system, and to send the one or more images to the control system. The control system may process the one or more images itself to determine the one or more movements to be performed based on the one or more images or may transmit the one or more images to an external computer system, using network hardware such as a wireless transceiver, so that the external computer system can determine the one or more actions to be performed based on the one or more images.

To assist in understanding of embodiments described herein, a specific example is initially presented. It should be understood that this specific example is provided for assistance in understanding these embodiments, and it should not be considered as limiting the scope of the claims or the description thereafter. In the following example, a navigation task will be discussed.

FIG. 1A is a plan view illustration of an example environment 10 that can be navigated using an agent in accordance with example embodiments.

The example environment 10 includes an autonomous vehicle 11 and a target object 12, e.g. a ball or vase, to be navigated to by the autonomous vehicle from its current position. As is illustrated, there are obstacles between the autonomous vehicle 11 and the target object 12. To avoid damage to the autonomous vehicle 11 and the obstacles, and to avoid getting stuck on the obstacles, the autonomous vehicle 11 avoids collisions with the obstacles when navigating to the target object 12.

The example environment 10 may be a cluttered indoor environment, e.g. an office or home, and may include obstacles such as tables, chairs, shelves, bookcases, storage units, boxes, electronic devices, and power cables.

FIG. 1B is an illustration of an autonomous wheeled vehicle 1, e.g. an automated guided vehicle, in accordance with example embodiments.

The autonomous wheeled vehicle 1 includes a body 2, wheels 3, and a sensor 4. The autonomous wheeled vehicle 1 may include additional elements to those shown, for example: a vacuum suction element such that the automated wheeled vehicle can be used as an automatic vacuum cleaner; and/or a fork and/or a cargo bed such that objects can be collected and/or delivered by the autonomous wheeled vehicle.

The body 2 includes one or more motors that can be used to rotate the wheels 3 and a steering system, e.g. a rack and pinion, whereby at least some of the wheels 3 can be turned to move in a desired direction. The body 2 also includes a control system, e.g. one or more computing devices that can be used to cause movements to be performed. For example, the control system may cause the wheels to be rotated by the motor to move the automated wheeled vehicle forwards (and, if supported, to rotate the wheels in the opposite direction, to move the autonomous vehicle backwards) and cause the steering system to rotate the wheels to turn the autonomous vehicle. The body 2 also includes a power source (e.g. a battery and/or a solar panel) or a connection to a power source (e.g. a mains connection) such that energy can be provided to the one or more motors, the steering system, and the control system.

The wheels 3 may include four wheels: the wheels 3a, 3b and two wheels (not shown) opposite to these, e.g. positioned against the opposite side (not shown) of the body 2 to the wheels 3a, 3b. Each two wheels of the four wheels, e.g. the wheel 3a and the wheel opposite, and the wheel 3b and the wheel opposite, may be connected by an axle extending through the body 2. At least one of the axles may be connected to the motor such that the respective two wheels connected to it can be rotated by the motor. At least one of the axles may be connected to the steering system such that the respective two wheels can be turned using the steering system.

FIG. 1C is an illustration of an autonomous aerial vehicle 5, e.g. an unmanned aerial vehicle or drone, in accordance with example embodiments.

The autonomous aerial vehicle 5 includes a body 6, propellers 7, and a sensor 8. The autonomous aerial vehicle 5 may include additional elements to those shown. For example, a payload holding or attachment element, such that the autonomous aerial vehicle can be used to collect and/or deliver objects.

The body 6 includes a respective motor for each of the propellers 7 which can be used to rotate the respective propeller. The body 6 also includes a control system, e.g. one or more computing devices that can be used to cause movements to be performed. For example, the control system may cause the motor to rotate the propellers and control the speed at which the motor rotates the propellers, such that the autonomous aerial vehicle can ascend and descend, move forwards and/or backwards, and turn. The control system may determine the movements to be performed itself, e.g. using the method described with respect to FIG. 1D, or may receive an indication of the action to be performed from an external computer system using network hardware, e.g. a wireless transceiver. The movements determined and/or received may be at a higher level of abstraction than the operations performable by the autonomous aerial vehicle, and the control system may translate these more abstract movements into operations performable by the aerial vehicle. For example, the more abstract movements may be move forwards, turn left and turn right, and the control system may translate these into differentials between the speeds at which the propellers 7 are rotated by the motor. The body 6 also includes a power source (e.g. a battery and/or a solar panel) or a connection to a power source (e.g. a mains connection) such that energy can be provided to the one or more motors and the control system.

The propellers 7 may include four propellers 7a, 7b, 7c and 7d. As described, each of the propellers 7a-7d may be rotated by a respective motor located on the body 6, and one or more of the propellers 7a-7d may be rotated at a different speed to another one or more of the propellers 7a-7d such that the aerial autonomous vehicle 5 turns left or right, or moves forward.

The camera 8 is capable of capturing images. In this embodiment, a single camera is provided capturing 2D images. The camera is coupled to the control system in the body 6. The camera is configured to capture one or more images, e.g. in response to a request received from the control system, and to send the one or more images to the control system. The control system may process the one or more images itself to determine the one or more movements to be performed based on the one or more images or may transmit the one or more images to an external computer system, using network hardware such as a wireless transceiver, so that the external computer system can determine the one or more actions to be performed based on the one or more images.

The sensor 4 is capable of capturing image data. In an embodiment, the camera is a light detecting and ranging (LiDAR) sensor. The sensor 4 is coupled to the control system in the body 2. The sensor 4 is configured to capture one or more images, e.g. in response to a request received from the control system, and to send the one or more images to the control system. The control system may process the one or more images itself to determine the one or more movements to be performed based on the one or more images or may transmit the one or more images to an external computer system, using network hardware such as a wireless transceiver, so that the external computer system can determine the one or more movements to be performed based on the one or more images.

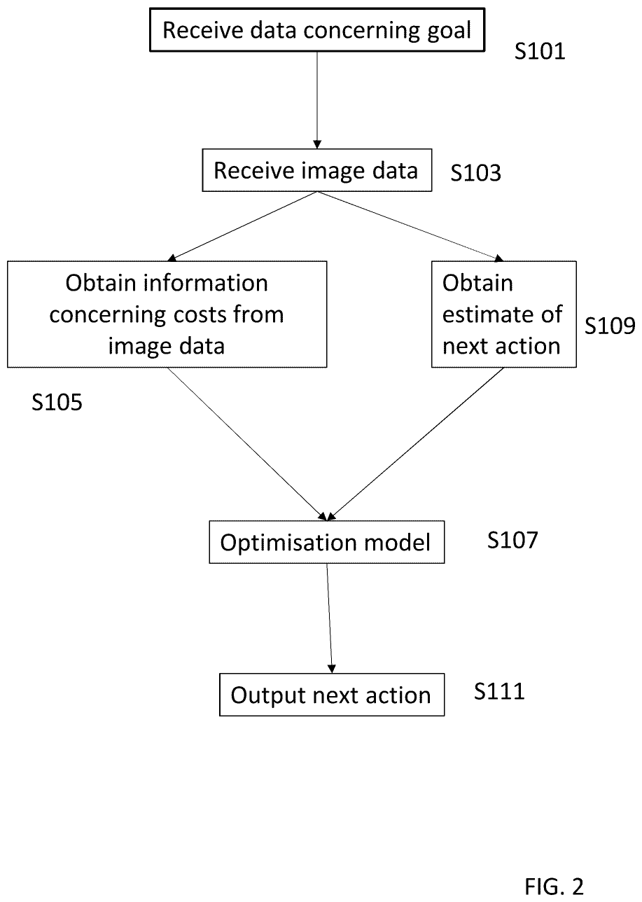

FIG. 1D is a schematic of the internal components of a vehicle. The vehicle comprises a computer system 110 which has a processor 112 and a memory 114. The computer system 110 receives an input from LiDAR sensor 140 and robot odometry sensors 140. The functions of the computer system will be described with reference to FIGS. 2 to 7. Once a next action has been determined, an instruction is sent to the controller 130 which controls steering device 140.

FIG. 2 is a flow chart showing a method of controlling an agent to perform a task. In step S101, data is received by the processor concerning the goal. To put the method into context, the method will be discussed in relation to the navigational task of FIG. 1A where the apparatus is a vehicle and the goal is a location which the robot has to reach. However, other options are possible, for example, the apparatus may be a robotic arm and the goal is to reach to an object. In practice, the method and system described herein can be applied to any model predictive control (MPC) process. For example, (i) Reach to grasp an object considering workspace constraints (example object in shelf); (ii). Manipulating: cutting/welding in a pattern; (iii). Fruit picking in agriculture robots; or (iv). Visual Inspection of workspace by drone. The goal may be a final goal or a sub-goal defining progress towards the goal.

In S103, image data is received. The image data may be any type of data relating to information concerning the physical surroundings of the vehicle from which a map of obstacles can be produced. In one embodiment, the image data is the output from one or more LiDAR sensors.

The image data collected in S103, is then processed in parallel branches. In a first branch, the image data is processed to determine information about the constraints on the process in step S105. The constraints are then provided as costs in optimisation model S107. In the optimisation model, a series of actions towards the goal are determined which have the lowest costs. In this simplified chart, just a single branch is shown for determining the costs. However, in practice, many parallel branches could be present. Also, additional costs which are provided to optimisation model S107 might not be derived from the image data obtained in step S103. In a navigation task, the constraints may be obstacles (static and/or dynamic), restrictions on the path such as the length on the path, restrictions provided by the vehicle etc.

The optimisation model in S107, a multidimensional costs landscape is produced and a path of lowest cost is found. This can be done using known optimisation techniques. To aid the optimisation model to converge to a good solution in an efficient manner, a first estimate of the next action is provided to the optimisation model in step S107. The next action is output from the optimisation model in S111.

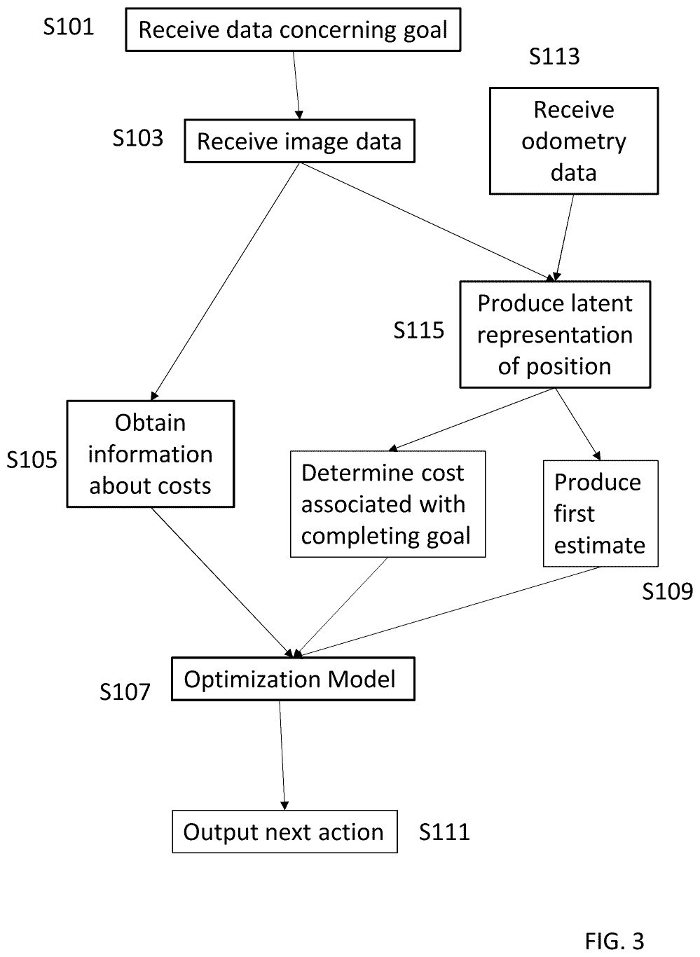

FIG. 3 is a flow chart of an implementation of the flow chart of FIG. 2 for a vehicle or robot performing a 2D navigation task in the presence of static and dynamic obstacles. The chart of FIG. 3 is a refinement of the flow chart of FIG. 2. Therefore, to avoid unnecessary repetition, like reference numerals will be used to denote like features.

In an embodiment, the problem of point goal navigation in 2D is set up from the current position of the vehicle (or robot) p=(pₓ, p_{y}) and a goal g=(gₓ, g_{y}) and current LiDAR sensor measurements x=(x₁, x₂, . . . x_{d}) at the current time instant t. The objective is to navigate the robot to the goal through a series of action control commands aₜ=(aₓ^{t}, a_{y}^{t}), avoiding n non-cooperative dynamic obstacles and static obstacles In an embodiment, the action control command is a velocity control command.

This problem may be formulated as a model predictive control (MPC) as follows:

$${π}^{*} = arg min {\sum }_{τ = t + 1}^{t + H} [ ‖ {p}_{τ} - g ‖ ] \qquad Eqn . ( 1 )$$

$$s . t . {p}_{τ + 1} = f ( {p}_{τ} , {a}_{τ} )$$

$${p}_{τ + 1}^{i} = {f}^{i} ( {p}_{τ}^{i} ) , ∀ i ∈ N$$

$$‖ {p}_{τ} - {p}_{τ}^{i} ‖ \geq δ , ∀ ∈ N$$

$$‖ {p}_{τ} - {s}^{j} ‖ \geq ϵ , ∀ j ∈ S$$

Where, π* is the optimal action sequence that minimizes future distance to the goal for a time horizon (H). Here, pₜ denotes the position of the robot, pₜⁱ denotes the position of i^{th} dynamic obstacle and s^{j} denotes the position of the j^{th} static obstacle t. It will be assumed that the robot's dynamics evolve by a function f and other dynamic agents evolve through fⁱ independent of the robot.

It will be assumed that the robot's dynamics evolve by a function f and other dynamic agents evolve through fⁱ independent of the robot.

In an embodiment the problem is modelled as a multi-task planning approach. In a specific embodiment, stochastic optimization is employed in latent space to solve all the sub-tasks in a joint framework. The MPC formulation in equation (1) can be rewritten as an unconstrained optimization problem as,

$${π}^{*} = arg min {\sum }_{t + 1}^{t + H} [ {C}_{t} ] , {C}_{t} = α {C}_{t}^{g} + β {C}_{t}^{0} + γ {C}_{t}^{s} \qquad Eqn . ( 2 )$$

Where:
Cₜ^{g} represents the goal reaching cost and can be represented as Cₜ^{g}=d_{G}(\hat{p}ₜ−g) which is the geodesic distance between current position and goal based on the current reconstruction of the map.
Cₜ⁰ represents the dynamic obstacle avoidance cost and can be represented as Cₜ⁰=Mₜ⁰(\hat{p}ₜ)
Cₜ^{m} represents the static obstacle avoidance cost and can be represented as Cₜ^{s}=Mₜ^{s}(\hat{p}ₜ)
α, β, γ are weights which can be set as required. In some embodiments, α, β, γ are all set to 1. However, different values can be set if it is required to increase and/or decrease the importance of one or more of the costs. Mₜ^{O}(p t) is a dynamic occupancy map which represents the probability of position p t being occupied by a dynamic obstacle at a time instance t and Mₜ^{s}(pₜ) is a static occupancy map which represents the probability of position p t being occupied by a static obstacle at a time instance t.

In an embodiment, the next position of the robot can predicted by a non-linear function ϕ (which may be implemented via a neural network such as a recurrent neural network) or true dynamics of the robots if known f. Similarly, a non-linear function ψ (which may be implemented via neural network) can be used to predict the collision probability map Mₜ^{O} for dynamic obstacles from LiDAR measurements, while the static occupancy map Mₜ^{s} can be reconstructed or predicted from LiDAR measurements.

In this embodiment a partially-reconstructed static occupancy map (Mₜ^{s}) representation is produced through classical grid mapping. In an embodiment, the static map is computed using simultaneous localization and mapping (SLAM) Mₜ^{s}=SLAM(p_{1:t},x_{1:t}). When constructing the static occupancy map, in an embodiment, the average of log-odds of probability of a position being occupied are used. Thus, if object moves then the probability of a position being occupied decreases over time.

A signed distance field (SDF) representation of the world over the partial occupancy reconstruction is also used that is updated after every few steps, since computing SDF is computationally expensive. A global planner (for example a fast marching method) is then used to generate waypoints from the partial SDF after every few steps. Furthermore, the static collision cost Cₜ^{m} can also be computed from occupancy map (Mₜ^{s}) by querying the probability of a position pₜ being greater than a threshold ϵ. In summary, the occupancy map is converted to Signed Distance Field (SDF) and then a global planner such as a Fast Marching Method (FMM) is run over the SDF and awaypoint is selected at a set number of steps away on the FMM path, for example 15 steps away.

Once the future states and corresponding costs are predicted by the RNNs, in an embodiment, a gradient free sampling based stochastic optimization framework is used to optimize the cost from equation 2.

How the above are derived will be explained with reference to FIG. 3. In step S101, data concerning the goal is provided. In this embodiment, the data concerning a goal, is provided in terms of a 2D location which the vehicle must reach. However, other options are possible, for example in the case of a vacuum cleaner, the intermediate goals (waypoints) may be given along a route that covers a designated area. Also another example is autonomous inspection when certain point of interests needs to be covered.

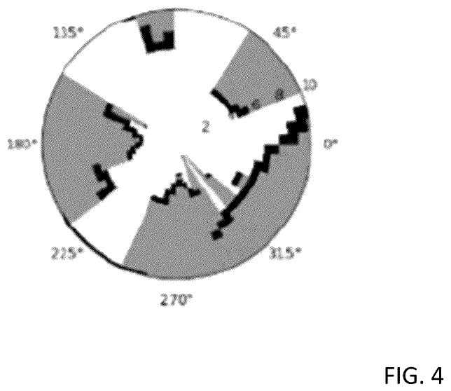

Image data is then received in step S103. As noted above, the image data may be data from a LiDAR sensor. FIG. 4, shows a typical “image” from a LiDAR sensor, the image being a polar image with the sensor itself at the centre of the image, the reflections of light signal sent by the LiDAR sensor shows the presence of obstacles. For processing the LiDAR image data may be converted into a matrix of occupancy probabilities or as a 1D vector of distances. The matrix may have a size of 64×64 and the 1D vector may have a size of 1080 units, thus the inputs to the neural network are large. The obstacles, may be dynamic obstacles which move in a predictable or unpredictable manner or the obstacles may be static obstacles.

In step S105, information about constraints are obtained. Although a single branch is shown for simplicity, in practice there may be multiple branches each modelling a different type of constraint to allow the constraint to be modelled as a cost in the optimisation step.

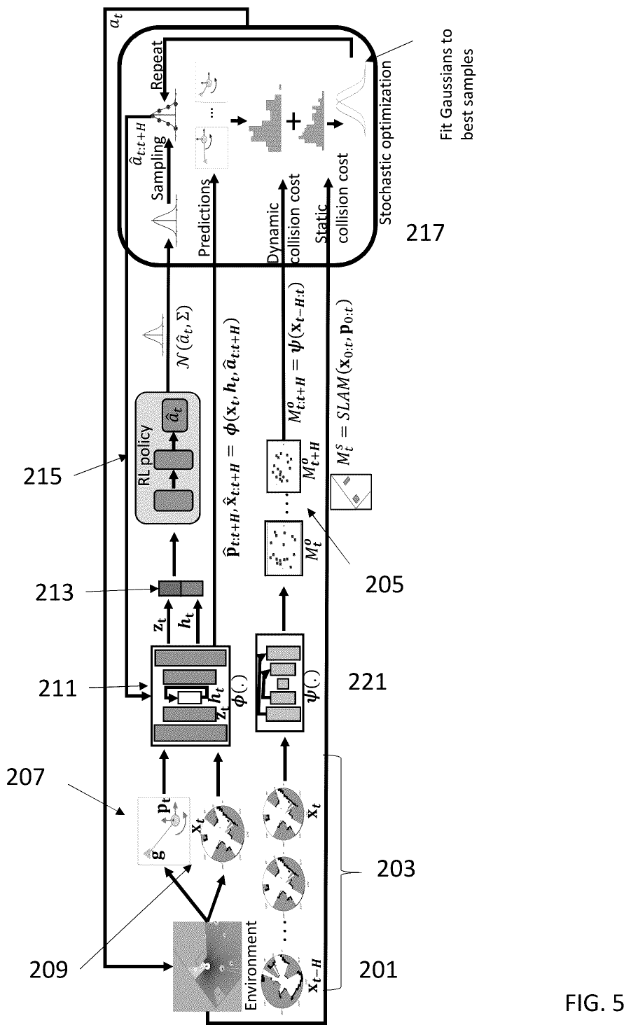

The modelling of the dynamic obstacles as constraints will be discussed next. The dynamic obstacle trajectories are learned through LiDAR measurements. This is shown more clearly in FIG. 5. The lower branch 201 of FIG. 5 shows a collection of Euclidean grid map representations of LiDAR measurements 203 which are taken over a time period H incremented in time steps t such that there are separate representations taken from time t-H to t. In an embodiment, the time steps t are time stamps for simulation and the frame rate for real experiments, for example a frame rate of 5 Hz may be used. These representations 203 are then stacked and used to predict dynamic occupancy maps 205 from which the costs of the constraint provided by the dynamic obstacles are determined. The dynamic occupancy maps represent the probabilities of positions being occupied by a dynamic object.

In an embodiment, this is achieved by training a spatio-temporal convolutional neural network, that stacks the Euclidean gridmap representation of previous LiDAR measurements (i.e. t−H to t) 203 to predict dynamic occupancy maps 205 for time interval t−H to t+H which is represented as M_{t:t+H}^{o}=ψ([x_{t-H}, . . . xₜ])

From this, the dynamic collision cost C_{t+τ}^{o} can be obtained from the dynamic occupancy map, The dynamic map is a function, where a query at a selected position on the map outputs the probability of the selected position being occupied. The probability of a given position (p_{t+τ}) being occupied should be lower than a threshold δ. In an embodiment, a U-net [J. Schulman, F. Wolski, P. Dhariwal, A. Radford, and O. Klimov “Proximal policy optimization algorithms,” arXiv preprint arXiv.1707.06347, 2017] style architecture is used for modeling ψ. In an embodiment, the channels represent temporally stacked frames thus the convolution operator learns over the spatio-temporal slice of the input data. Hence it will be referred to as a spatio-temporal network. In a further embodiment, a recurrent neural network could also be used to provide non-linear function ψ.

In an embodiment, a further branch 201 is provided to model the costs due to static obstacles. Here, the LiDAR inputs 203 (explained in the dynamic branch) are used to produce an occupancy map which is maintained by a SLAM system (not shown). This branch outputs Mₜ^{s}(pₜ)=SLAM(x_{0:t}, p_{0:t}) where Mₜ^{s}(pₜ) is the collision (occupancy) map maintained by the SLAM system. This can be thought of as a memory or a function that returns collision probability given a position/robot state.

Here, in addition to receiving of image data 209 which in this embodiment it LiDAR data, odometry measurements are obtained in S113. The odometry measurements 209 indicate the change in the vehicles position from sensors on the vehicle, for example accelerometers etc.

The odometry measurements, the goal and the image data are used to predict an estimate of the sequence of movements that the vehicle needs to perform to reach the goal. This estimate is then used as an input to the stochastic model. The image data and the odometry data provide the state of the vehicle. In an embodiment, the sequence is estimated (plan for a horizon, â_{t+1:t+H} but when run only the first action âₜ₊₁ is used.

In an embodiment, to encode the dynamic model of the vehicle, a state space model is employed that comprises a convolutional variational autoencoder (VAE) and a recurrent neural network (RNN) 211 as shown in FIG. 5.

The inputs to the state space models are:
First the latent representation from Lidar measurements is provided:
1. Zₜ=VAE(Xₜ)
This is then concatenated with last action and the relative goal to RNN
2. hₜ₊₁=RNN([zₜ,g−pₜ,aₜ₋₁]hₜ),
The, the decoder is used to predict the positions and next measurements.
3. \hat{x}ₜ₊₁,pₜ₊₁=decoder(hₜ)

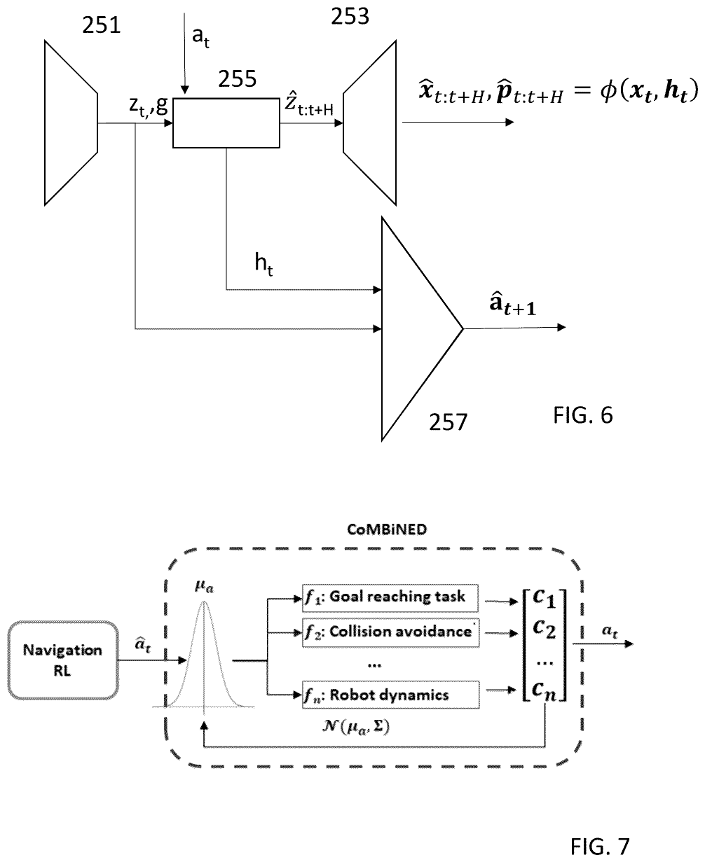

The arrangement and operation will be described in more detail with reference to FIG. 6. Here, the VAE is represented as encoder 251 and decoder 253. The purpose of the VAE is to take image data xₜ from the LiDAR sensor and compress it into a latent representation zₜ such that there is a temporal sequence of latent representations corresponding to the input temporal sequence of LiDAR observations. In addition, the goal is also encoded using encoder 251 to produce a latent representation of the goal.

The latent representation zₜ and the goal g is then provided to the input of RNN 255. RNN 255 serves as a predictive model of future zₜ vectors that the encoder is expected to produce. In an embodiment, the RNN is trained to output a probability density function p(z) instead of a deterministic prediction of z. Many options are available for parameterizing p(z). In an embodiment, p(z) is expressed as a Gaussian mixture model which is a sum of a plurality of Gaussian distributions Thus, the RNN models the conditional probability P(zₜ₊₁|aₜ,zₜ,hₜ) where a t is the action at time t and hₜ is the hidden state of the RNN at time t. The action aₜ in this embodiment, is a velocity which can be represented as a=[vₓ,v_{y},ω] where vₓ,v_{y},ω∈[−1, 1]. The action aₜ is obtained from the odometry measurements. The RNN predicts zₜ up to time horizon H, i.e. \hat{z}_{t:t+H}.

The latent representation of the observations at time t, zₜ and the hidden state of the RNN at time t, hₜ are then stacked and provided to reinforcement learning module 257. As RNN's 255 prediction of zₜ₊₁ is produced from the RNN's hidden state hₜ at time t, hₜ provides a good candidate for a feature vector for RL module 257. Combining zₜ with hₜ gives RL module 257 a good representation the current observation and what to expect in the future. In an embodiment, the next action âₜ is predicted by the reinforcement learning module and this is repeated H times to obtain an initial guess for the optimisation. In a further embodiment, the reinforcement learning module is used to predict âₜ₊₁:â_{t+H} recursively.

In an embodiment, the output of the RL module 215/257 is a prediction of the next action of the vehicle âₜ₊₁. However, in other embodiments, the RL module 257 could be trained to predict a sequence of actions â_{t+1:t+H}.

In an embodiment, a Normal distribution with the mean as initial solution provided by RL policy âₜ₊₁=RL(xₜ, pₜ) and a predefined variance Pₜ= [symbol] (μ=aₜ₊₁, Σ) is fitted. For the embodiments where the RL just predicts âₜ₊₁, a trajectory is predicted, i.e. âₜ₊₁=âₜ₊₂, etc

In addition, decoder 253 is used to output probability distributions of the predicted observations \hat{x}_{t:t+H} and the corresponding probability distributions of the predicted positions of the vehicle \hat{p}_{t:t+H} are provided to the stochastic optimizer. This is then used as an input into the stochastic optimiser 217.

The above estimate of âₜ₊₁, is also used to input into the stochastic optimizer using a cross entropy method (CEM). The distribution is then sampled to obtain N sample trajectories with the j^{th} sample is given as (A^{j}=[aₜ₊₁^{j}, aₜ₊₂^{j}, . . . a_{t+H}^{j}]) this prior distribution [symbol] . For the embodiments where the RL just predicts âₜ₊₁, a trajectory is predicted, i.e. âₜ₊₁=âₜ₊₂, etc. Where the RL outputs an estimate for â_{t+1:t+H} a normal distribution is fitted for each value of the predicted output.

These samples are propagated from all state space models of the constraints to obtain next states (\hat{P}^{j}=ϕ(pₜ^{j}, xₜ, A^{j}), M^{sj}(\hat{P}^{j})) and mean expected cost C^{j} for a sample j for all time horizons i.e. \hat{P}^{j}=[\hat{p}^{j},\hat{p}ₜ₊₁^{j}, . . . \hat{p}_{t+H}^{j}]. The costs are calculated using eqn (2).

Then, the N samples are sorted in descending order of the rewards (rewards=−cost) and K-elite samples are selected corresponding to minimum C Following the CEM optimization process, a normal distribution is again fitted with means and variance for each of the K-elite samples. The process is repeated till the mean expect cost does not decrease by a threshold. Finally, the best action is selected and this is provided to the vehicle in the receding horizon fashion. In the receding horizon planning approach, a plan is made for a fixed horizon H but only the next action âₜ₊₁. is used. Then a new set of observations is made and the next plan is made for H time-steps.

In an example, there is 1 distribution for each time step (in total H distributions). From this N samples are selected from the distribution at each time step. Since each action is represented in 2 dimension, this gives an N×H×2 matrix for H time steps.

Next these N samples per time step are passed to all the constraints. In this embodiment, there are two constraints and one goal reaching cost, thus we get N×H×3 matrix of cost.

Next, the average cost per sample per time step is determined, resulting in an N×H matrix.

Then for every time step k-elite samples are selected with minimum cost. this gives k×H×2 matrix (since each action is 2D). Then a normal distribution is fitted to these k samples. This results in H Normal distributions each having a 2D mean and a 2D (diagonal) variance.

N samples are again selected from these H distribution giving a matrix of N×H×2 and repeat the process until convergence. In an embodiment, the process is terminated after 8-10 iterations to avoid delays in the process.

In an embodiment, the vehicle continuously takes the last sensor measurements from the buffer/memory and writes the action command to the buffer/memory of the vehicle/robot. This implementation helps in having planner to update at a different rate since compared to sensors as all sensors refresh at a different rates.

In the above, for simulation, the position pₜ may be obtained from robot's odometry. In real scenarios pₜ comes from SLAM (LiDAR+IMU+odometry). An Inertial Measurement Unit (IMU) is a sensor comprising of accelerometer, gyroscope and magnetometer. It uses the accelerometer, gyroscope and magnetometer and outputs accelerations and angular velocity. SLAM is a separate thread and continuously updates the pₜ and Map in a buffer. In an embodiment, the current pₜ is used from the buffer when xₜ is queried for the VAE encoder. Note that it is assumed that zₜ, map, and pₜ remain same during the stochastic optimization step.

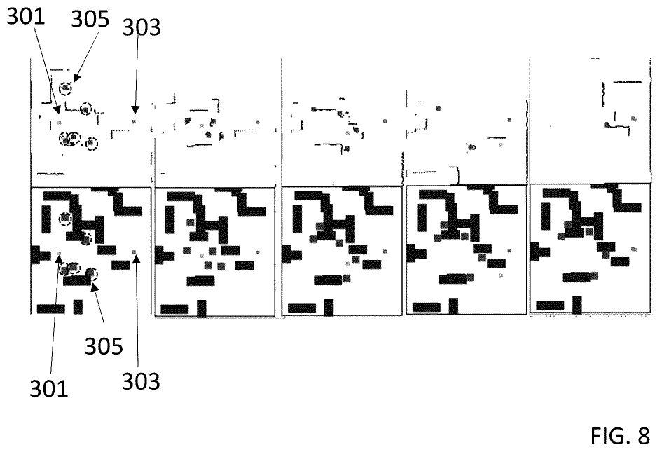

FIG. 7 shows summary of the above optimization.

In an embodiment, an algorithm using the following pseudo code could be used.
Algorithm 1: Multi-constrained online planning using CEM
Inputs: Constraints as state-space models RNNs/kino-dynamical and respective costs
Input: Initial action guess from RL approach
Fit Gaussian distribution around the initial guess while M-iterations do
Propagate samples through all models for for H-steps
Collect the mean expected reward for all samples Select K-elite samples with maximum rewards
Fit a new Gaussian distribution on them end
Return: Best action

This is shown in the diagram of FIG. 5 within the stochastic optimisation 217.

Returning to FIG. 5, the training of the system will now be explained. As the costs are combined at the stochastic optimiser 217, the neural networks that determine the costs can be separately trained from one another.

In an embodiment, the neural network ψ that is used to produce the dynamic occupancy maps is trained separately to the rest of the system. In an embodiment, the neural network ψ is trained in a supervised manner using a ground truth map with obstacles, for example between 0 to 15 obstacles.

In an embodiment, both the VAE and RNN (LSTM) that form ϕ are jointly trained. For example, training data may be obtained by randomly moving the agent and collecting data.

In an embodiment, the RL module is trained separately.

The above allows neural networks that are used to model the constraints to be trained separately from each other. Thus, constraints can be added or removed without the need to re-train other constraints or the robot's dynamic model.

In an embodiment, the following structures can be used:

For the VAE for the robot's dynamic model (ϕ), a similar architecture to Navrep may be used. In this example, the VAE comprises a 4-layer convolutional neural network (CNN) encoder, which is then followed by a 2-layer dense layer, and 4-layer CNN decoding blocks. The latent features z are of size 32, and the hidden features of the RNN (LSTM) are of size 64. The value network of the RL policy comprises of 2-layer dense network.

For the dynamic obstacle branch a U-net style architecture [O. Ronneberger, P. Fischer, and T. Brox, “U-net: Convolutional networks for biomedical image segmentation,” in International Conference on Medical image computing and computer-assisted intervention, pp. 234-241, Springer, 2015.] may be used.

The LiDAR measurements are converted to grid maps of size (140×140), 4-grid maps from (t=t−4:t=t) are stacked in form of (140×140×4) tensor, which is input to the U-net. The U-Net output comprises of (140×140×8) tensor, which represents 8-gridmaps with probability distributions of dynamic obstacles from (t−4:t+4).

In a specific example, the dynamic models are trained with 1000 trajectories each of length 200, extracted by controlling the robot using ORCA policy for varying number of static and dynamic obstacles between 10 and 15. Furthermore, in an embodiment, leg movement was used to render dynamic agents as moving legs in the generated LiDAR data and a time-step of 0.2 s was used for updating the agents' positions.

In an embodiment, pre-trained models provided by Dugas et al. [D. Dugas, J. Nieto, R. Siegwart, and J. J. Chung, “Navrep: Unsupervised representations for reinforcement learning of robot navigation in dynamic human environments,” in 2021 IEEE International Conference on Robotics and Automation (ICRA), pp. 7829-7835, IEEE, 2021.] are used for the robot's dynamics and RL policy. The RL policy may be RL policy with a policy gradient. In a further embodiment the RL policy is a PPO policy (see for example Proximal Policy Optimisation Algorithms J. Shulman et al arXiv:1707.06347).

The dynamic obstacles' state space models were trained for 200 epochs using the popular Adam optimizer with learning rate 1^{e-4}. Also, random cropping and random rotations were used as data augmentations for training the U-net. For CEM optimization, the following were used: horizon length H=4; initial variance 0.8; number of samples=256; and number of K−elite samples=32. The was optimized for 6 iterations. These hyperparameters of CEM were empirically selected based on Navrep train simulation environment

| 5 dynamic and 5 static obstacles | Success Rate (%) |
|---|---|
| FIG. 5 arrangement | 69 |

While the approach can be applied to any multi-constrained inference problem, the specific example provided here dynamic obstacle avoidance, where the agent needs to reach a point-goal by moving in an obstacle-free space (navigation task) and avoid moving obstacles (dynamic obstacle task).

The approach was evaluated on an environment with 5 moving obstacles and 5 objects in a small space averaged over 100 trajectories. The evaluation results are shown in table I. FIG. 8 shows an example trajectory of our approach where the robot needs to coordinate with other agents due to tight space constraints. FIG. 8 shows examples of robot navigating in a complex dynamic scene from the validation set in Navrep simulation environment. The top 5 examples are online reconstructions of the current environment, where robot 301 navigates to a goal 303 avoiding dynamic obstacle detections by our dynamic obstacle prediction network 305 (dotted lines shown around dynamic obstacles). The lower 5 figures are the ground truth map.

The above system was also evaluated on Navrep's publicly available simulation benchmark without any retraining or fine tuning, where the model was tested in 18 unseen scenarios (2 maps ‘asl’ and ‘unity’, 9 scenarios each) for 50 times every scenario. The scenario definitions and selection was fixed before any testing took place to avoid bias.

The results are shown in Table II

| Approach | Success Rate (%) |
|---|---|
| Without true map | 51.1 |
| with true map | 90.4 |

TABLE II: Quantitative results on navrep benchmark on 18 pre-defined scenarios. Strong results are shown with-and-without map showing the strengths of the above system which can optimize the policy online.

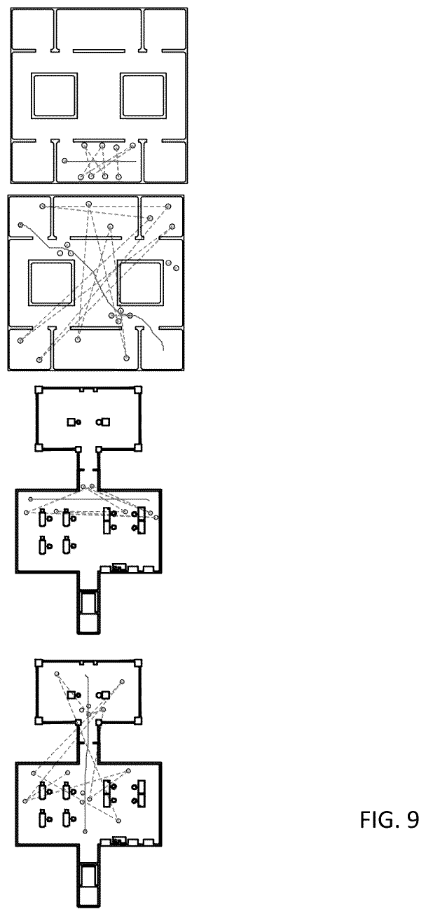

A few examples of these scenes are shown in FIG. 9 In FIG. 9, the solid line shows the motion of the robot and the dotted lines show the motion of the dynamic obstacles. There are variations in behaviour of the dynamic obstacles, few obstacles even remain static. This poses challenge to DRL policies trained only from LiDAR measurements since the policy expects these obstacles to move. The embodiments described herein use a different approach to address this issue as described above.

The above was evaluated using an Intel-xeon-E5 processor with 128 GB RAM, and a Nvidia-Titan-x GPU, after evaluation it was found that for a Navrep planner the policy evaluation time is 0.02 sec., whereas for a non-parallel single core implementation of the arrangement of FIG. 5 takes 0.2 sec., for 256 samples and 32 k-Elite samples, with horizon length 4 and 6 optimization steps. The advantage of using CEM in the stochastic optimisation is that the process of sampling can be made highly parallel. It is observed that the parallel implementation of the above takes around 0.08 sec. Thus the above can be implemented on real robotic system.

The above embodiments provide a novel planning framework that can combine several constraints, both deep and analytical, and solve them in continuous space jointly using stochastic optimization on-the-fly without any retraining of the models. They provide a safe indoor navigation approach that can steer a robot through complex environments in the presence of dynamic obstacles using LiDAR measurements and odometry.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. An apparatus for performing a task, the task being a sequence of actions performed to achieve a goal, the apparatus comprising:
at least one sensor for obtaining observations of the apparatus;
a controller configured to receive a control signal to move said apparatus; and
a processor,
said processor being configured to:
receive information concerning the goal;
determine the sequence of actions to reach said goal, the sequence of actions being subject to at least one constraint; and
provide a control signal to said controller for the next action in said sequence of actions,
wherein said processor is configured to determine the sequence of actions by processing observations received by said sensors to obtain information concerning the at least one constraint and performing stochastic optimisation to determine the sequence of actions, where the at least one constraint is represented as a cost in said stochastic optimisation, the stochastic optimisation receiving an initial estimate of the next action.

2. The apparatus of claim 1, wherein the initial estimate is obtained from a reinforcement learning policy.

3. The apparatus of claim 1, wherein the processor is configured to process observations concerning the constraints using a plurality of parallel processing branches, such that each branch is allocated to a different constraint.

4. The apparatus of claim 1, wherein the task comprises moving at least part of an apparatus to achieve a goal, the sequence of actions being a sequence of movements.

5. The apparatus of claim 4, wherein the apparatus is a vehicle, the task is a navigation task and the goal is a location.

6. The apparatus of claim 5, wherein at least one of the constraints comprises navigating to avoid dynamic obstacles.

7. The apparatus of claim 6, wherein the processor is configured to process a constraint relating to avoiding dynamic obstacles by producing an occupancy map of the dynamic obstacles.

8. The apparatus of claim 7, wherein the processor is configured to produce an occupancy map of the dynamic obstacles using a neural network, wherein the input for the neural network is a time series of earlier observations of the dynamic obstacles.

9. The apparatus of claim 5, wherein at least one of the constraints comprises navigating to avoid static obstacles.

10. The apparatus of claim 5, wherein at least one of the constraints requires the apparatus to move the shortest distance to reach the goal.

11. The apparatus of claim 1, wherein there are a plurality of constraints, the processor being configured to apply a weighting to each costs derived from a constraint such that the costs are applied with variable weightings.

12. The apparatus of claim 2, wherein the input to the reinforcement learning module is a hidden state of a recurrent neural network “RNN”, the RNN being used to produce predictions of at least one future observation.

13. The apparatus of claim 12, wherein an input to the RNN is a latent representation of the observations.

14. The apparatus of claim 13, wherein a further input to the RNN is the goal.

15. The apparatus of claim 13, wherein the processor is configured to provide probabilities relating to predictions of future observations from the RNN to the stochastic optimiser.

16. The apparatus of claim 1, wherein the processor is configured to input an estimated sequence of actions to reach the goal as an input estimate into the stochastic optimiser.

17. The apparatus of claim 1, wherein the observations are LiDAR data.

18. The apparatus of claim 2, wherein the reinforcement learning policy is a proximal policy optimisation algorithm.

19. A method for performing a task, the task being a sequence of actions performed to achieve a goal, the method comprising:
receiving information concerning the goal at a processor;
determining the sequence of actions to reach said goal, the sequence of actions being subject to at least one constraint; and
providing a control signal to a controller for the next action in said sequence of actions,
wherein the sequence of actions is determined by processing observations received by sensors to obtain information concerning the at least one constraint and performing stochastic optimisation to determine the sequence of actions where the at least one constraint is represented as a cost in said stochastic optimisation, the stochastic optimisation receiving an initial estimate of the next action.

20. A non-transitory computer-readable medium comprising instructions which, when executed by a computer, cause the computer to carry out the method of claim 19.
